(19) United States
(12) Patent Application Publication
(10) Pub. No.: US 2020/0198819 A1
(43) Pub. Date: Jun. 25, 2020

(54) Tape sealing machine suitable for various sizes of express boxes

(71) Applicant: Weilong Wang, Weihai City (CN)

(72) Inventor: Weilong Wang, Weihai City (CN)

(21) Appl. No.: 16/809,588

(22) Filed: Mar. 5, 2020

(30) Foreign Application Priority Data
Dec. 2, 2019 (CN) 2019112157069

(51) Int. Cl. B65B 51/06; B65B 61/06; B29C 65/50

(52) U.S. Cl. CPC B65B 51/067; B29C 65/50; B65B 61/06

(57) ABSTRACT

The invention discloses a tape sealing machine suitable for various sizes of express boxes, including a sealing machine. The left side of the sealing machine is provided with a left telescopic cavity with an opening downward and leftward, and the left telescopic cavity can slide left and right. There is a left telescopic plate on the right side of the sealing machine, and a right telescopic cavity with an opening downward and to the right is provided on the right side of the sealing machine. A right telescopic plate is slidable in the right telescopic cavity. The right and left telescopic plates are provided with a pressing roller device. The present invention presses the sealing machine on the upper side of the express box to flatten the two cardboards at the opening of the express box, and then press the tape on the cardboard. The sealing between the seams is continued. Pressing down the sealing machine can drive the pressure rollers away from each other to the sides of the delivery box, and then flatten the tape on the delivery box. The sealing machine has good flexibility, and the pressure roller can The fixed range is large, and it can be applied to a variety of sizes of courier boxes.

### CROSS-REFERENCES TO RELATED APPLICATIONS

The present application claims priority from Chinese application No. 2019112157069 filed on Sep. 19, 2019 which is hereby incorporated by reference in its entirety.

### TECHNICAL FIELD

The invention relates to the technical field of sealing, in particular to an adhesive tape sealing machine suitable for various sizes of express boxes.

### BACKGROUND OF THE INVENTION

With the continuous development of express delivery and logistics, a large number of courier services need to be transported every day. Some courier choose to use courier boxes to package the courier, and the courier boxes are generally corrugated boxes. The final opening needs to be sealed with tape. Because the corrugated cardboard box has a certain hardness, the two pieces of paper at the upper opening will still be turned upside down after being folded. As a result, it is difficult to stick the tape, and the sticking is not flat, which leads to incomplete sticking. It needs to be refilled several times to make up the tape, which wastes the tape. Flattening, it is still difficult for one person to operate, and it is more troublesome to use. The present invention illustrates a device capable of solving the above problems.

### BRIEF SUMMARY OF THE INVENTION

### Technical Problem

In order to solve the above problems, this example designs a tape sealing machine suitable for various sizes of courier boxes, and a tape sealing machine suitable for various sizes of courier boxes in this example, including a sealing machine. A left telescopic cavity with an opening downward and to the left is provided on the side, and a left telescopic plate is slidably provided with the left telescopic cavity, and a right telescopic cavity with an opening downward and to the right is provided on the right side of the sealing machine. A right telescopic plate is provided in the right telescopic cavity to be able to slide left and right, and a press roller device is provided in the left telescopic plate and the right telescopic plate, as well as a lower side, and the left telescopic plate is provided in the left telescopic plate. And the slanting sliding cavity in the right telescopic plate and the opening is downward, and slanting sliders are provided in the slanting sliding cavity, and the upper end of the slanting slider is in contact with the slanting surface of the upper wall of the slanting cavity, The slanted surface sliders can slide along the slanted surface to move away from each other. A pressure roller is provided on the lower side of the slanted surface slider to pull the tape to the lower side of the pressure roller. The pressure rollers are far away from each other, and then the tape is flattened from the middle to the two sides, and the right is stretched. The right end is fixedly provided with a fixing block located on the right side of the sealing machine, a cutting device is provided in the fixing block and the right telescopic plate, and the cutting device is provided with an opening located in the fixing block downward and to the right. The cutting cavity is provided with a cutting knife on the left side. When the upper end of the cutting knife is turned to the right, the tape can be punctured and cut off. The upper side of the sealing machine is provided with a manual control device. The control device is provided with a turntable, and the turntable is dynamically connected to the cutting blade, and the rotation of the cutting blade can cause the cutting blade to be turned over.

Preferably, a limiting cavity is provided in communication with the upper wall of the left telescopic cavity and the right telescopic cavity, and the left and right telescopic plates in the limiting cavity can be slidably connected to the left telescopic plate and the right telescopic plate, respectively. An upper limit block, a return spring is fixedly connected between an end of the limit block far from the center and the inner wall of the limit cavity. When the limit blocks move away from each other, the reset spring is compressed, and the reset spring may Provide power for resetting the limit block.

Wherein, the pressure roller device includes a guide bar fixedly arranged between the left and right walls of the inclined slide cavity and slidably connected to the inclined surface slider, and the guide slide bar remains the same as the upper wall of the inclined slide cavity. The inclination angles of the guide slide bar, the upper wall of the inclined slide cavity and the upper end of the inclined slide are low near the center and high away from the center. A compression chamber in which a compression plate can be slid up and down. A fixed plate is fixed at the lower end of the compression plate away from the center of symmetry. The lower end of the fixed plate extends to the lower side of the slanted slider. A rotating shaft is rotatably provided between the lower ends of the fixed plates, and the pressure roller is fixedly disposed on an outer circular surface of the rotating shaft.

Preferably, a compression spring is fixedly connected between an end of the inclined surface slider far from the center and the inner wall of the inclined slide cavity. When the inclined surface slider moves to a side away from the center of symmetry, the compression spring is pressed. The compression spring can provide power for the slanted surface slider to move toward the center. A compression spring is fixedly connected between the upper end of the compression plate and the upper wall of the compression cavity. When the compression plate moves and compresses, When the pressing spring is pressed, the pressing spring can provide power for the compression plate to move downward.

Wherein, the cutting device comprises a rotating column which is rotatably connected to the lower left corner between the front and rear walls of the cutting cavity, the cutting blade is fixedly arranged at the upper end of the outer circular surface of the rotating column, and the rotating column axis is fixedly provided with a turning A sprocket cavity extending to the upper right side of the right telescopic plate at the rear side of the cutting cavity, and a driven sprocket fixed to the sprocket cavity at the rear end of the turning shaft, the chain A driving sprocket is provided on the left side of the wheel cavity and is rotatable in the right telescopic plate. A driving chain is wound between the driving sprocket and the driven sprocket. The driving sprocket axis is fixedly arranged. There is a transmission shaft. The front wall of the sprocket cavity is directly opposite to the front side of the driving sprocket. A transmission cavity located on the upper side of the inclined slide cavity on the right side is provided. The front end of the transmission shaft extends into the transmission cavity and is fixed. A driven bevel gear is provided, and a spline hole shaft penetrating the right telescopic plate is rotatably provided in the left wall of the transmission cavity, and a right end of the spline hole shaft is fixedly provided with the driven bevel gear. In the active bevel gear, a spline connected to the left end of the spline hole shaft and connected to the left wall of the right telescopic cavity is splined.

Preferably, the upper end of the fixing block is fixedly provided with a tape placement box, the tape placement box is provided with a placement cavity, and the back wall of the placement cavity is fixedly provided with a sleeve rod that can be placed in the center of the tape, under the placement cavity. A tape opening is provided between the wall and the upper wall of the cutting cavity. The initial end of the tape can enter the cutting cavity through the tape opening.

Wherein, the manual control device includes a turntable cavity provided in the upper end surface of the sealing machine, a power shaft is rotatably provided at the center of the lower wall of the turntable cavity, and the turntable is rotatably provided in the turntable cavity and fixed. It is provided at the upper end of the power shaft, a bevel gear cavity is provided on the lower wall of the turntable cavity, the lower end of the power shaft extends into the bevel gear cavity, and a power bevel gear is fixedly fixed, and the left end of the spline shaft extends to the A transmission bevel gear meshing with the power bevel gear is fixed in the bevel gear cavity.

Preferably, a torsion spring is fixedly connected between the lower end of the turntable and the lower wall of the turntable cavity, and the torsion spring can be tightened by rotating the turntable, and the torsion spring provides power for the turntable resetting of the turntable. A handle is fixed on the upper end of the turntable, and the handle can be used to hold the sealing machine and drive the turntable to rotate.

Preferably, a pressing cavity is symmetrically provided on the front and back sides of the sealing machine, and a sliding plate is provided in the pressing cavity. The upper end of the sliding plate and the upper wall of the pressing cavity are fixedly connected with a pressing spring. The pressing spring can provide power to move the sliding plate downward. A connecting plate extending to the lower side of the sealing machine is fixed at the lower end of the sliding plate, and a pressing plate is fixed to the lower end of the connecting plate. Slightly lower than the lower end of the pressure roller.

The beneficial effect of the present invention is that by pressing the sealing machine on the upper side of the express box, the present invention first flattens the two cardboards at the opening of the express box, and then presses the tape on the seam between the cardboards to seal. Continue pressing down the sealing machine can drive the pressure rollers away from each other to the sides of the delivery box, and then flatten the tape on the delivery box, and the sealing machine has good flexibility, the pressure roller can be fixed in a larger range, can It is suitable for a variety of sizes of courier boxes, and has good storage and small space, and can be cut by turning the handle. The operation is convenient and the sealing effect of the tape is better.

### BRIEF DESCRIPTION OF THE DRAWINGS

For ease of explanation, the present invention is described in detail by the following specific embodiments and the accompanying drawings.

FIG. 1 is a schematic diagram of the overall structure of a tape sealing machine suitable for various sizes of express boxes of the present invention; FIG.

FIG. 2 is a schematic structural diagram of the direction “A-A” in FIG. 1; FIG.

FIG. 3 is a schematic structural diagram of the direction “B-B” in FIG. 1; FIG.

FIG. 4 is an enlarged schematic view of the structure of “C” in FIG. 2.

### DETAILED DESCRIPTION OF THE INVENTION

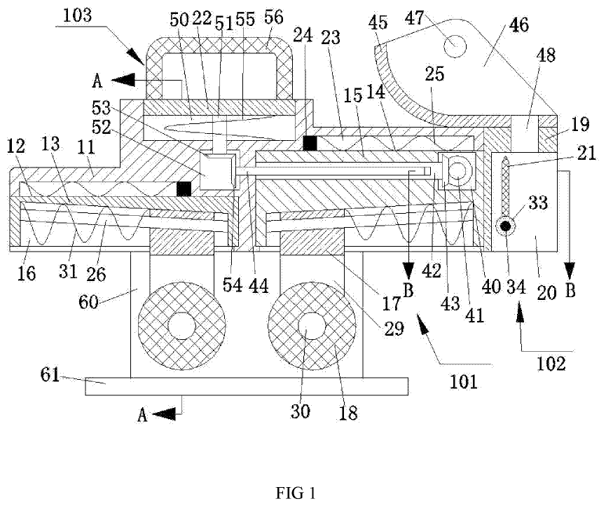

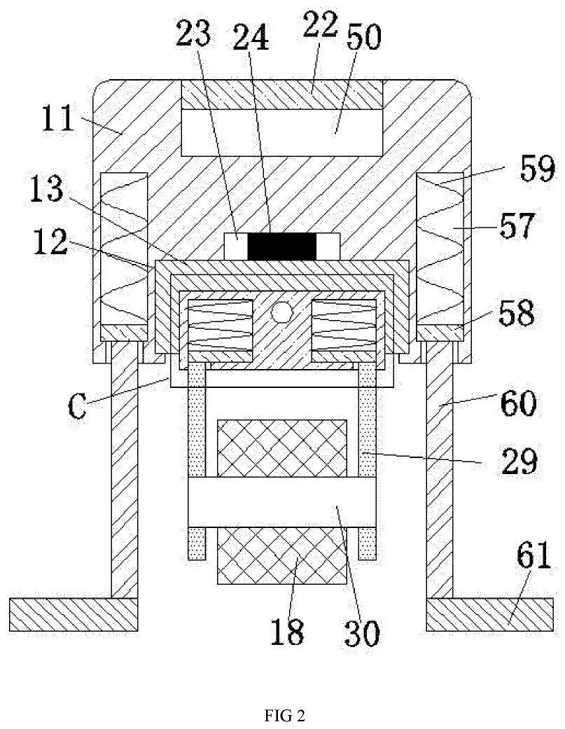

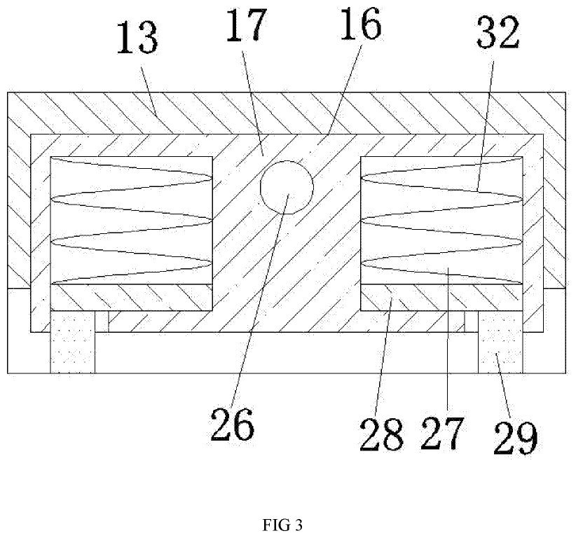

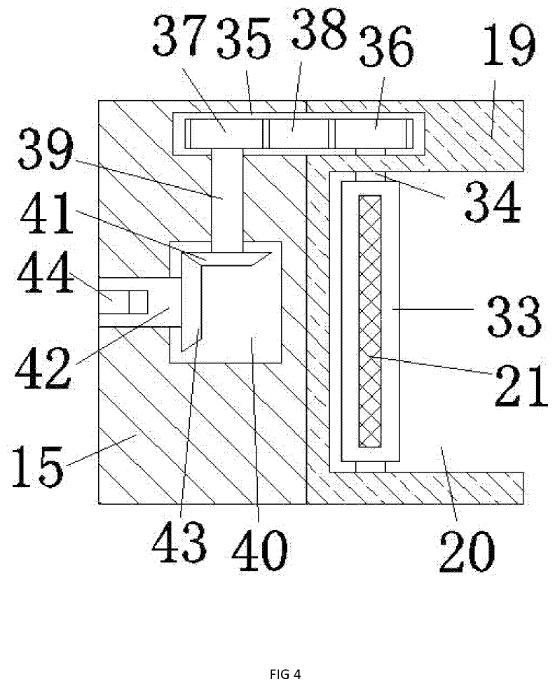

The present invention will be described in detail below with reference to FIGS. 1-4. For convenience of description, the orientation described below is defined as follows: the up-down, left-right, and front-back directions described below are consistent with the up-down, left-right, and front-back directions of the projection relationship of FIG. 1 itself.

The present invention relates to a tape sealing machine suitable for various sizes of courier boxes, and is mainly used for sealing the tape when packaging courier boxes. The invention will be further described below with reference to the accompanying drawings of the invention:

A tape sealing machine suitable for various sizes of express boxes according to the present invention includes a sealing machine 11 which is provided with a left telescopic cavity 12 with an opening downward and leftward in the left side of the sealing machine 11, the left telescopic A left telescopic plate 13 is provided in the cavity 12 to be able to slide left and right, and a right telescopic cavity 14 having an opening downward and to the right is provided on the right side in the sealing machine 11, and a right telescopic is provided in the right telescopic cavity 14 to be able to slide left and right. Plate 15, the left telescopic plate 13 and the right telescopic plate 15 are provided with a pressure roller device 101 inside and below, and the pressure roller device 101 is provided with the left telescopic plate 13 and the right telescopic plate 15 inside An inclined slide chamber 16 with an inner opening downward is provided with an inclined slide block 17 slidable in the left and right. The upper end surface of the inclined slide block 17 abuts against the inclined surface of the upper wall of the inclined slide chamber 16. The slanted surface sliders 17 can slide along the slanted surface to move away from each other. A pressure roller 18 is provided on the lower side of the slanted surface slider 17 to pull the adhesive tape to the lower side of the pressure roller 18. When the slanted surface sliders 17 are away from each other The pressure rollers 18 can be driven away from each other, and then the tape is flattened from the middle to the two sides. A fixing block 19 on the right side of the sealing machine 11 is provided with a cutting device 102 in the fixing block 19 and the right telescopic plate 15, and the cutting device 102 is provided with an opening in the fixing block 19 facing downward and to the right. The cutting chamber 20 is provided with a cutting blade 21 on the left side. When the upper end of the cutting blade 21 is turned to the right, the tape can be punctured and cut off. The upper side of the sealing machine 11 is provided with a manual control. Device 103. The manual control device 103 is provided with a turntable 22 therein. The turntable 22 is dynamically connected to the cutting blade 21, and when the rotating plate 22 is rotated, the cutting blade 21 can be driven to turn over.

Beneficially, the left telescopic cavity 12 is connected with the upper wall of the right telescopic cavity 14 with a limiting cavity 23, and the limiting cavity 23 is slidably provided with a left and right sliding cavity respectively fixedly connected to the left telescopic plate 13 and the The limiting block 24 at the upper end of the right telescopic plate 15 is fixedly connected with a return spring 25 between the end far from the center and the inner wall of the limiting cavity 23. When the limiting blocks 24 move away from each other, they will compress. The reset spring 25 can provide power for resetting the limiting block 24.

According to the embodiment, the roller pressing device 101 is described in detail below. The roller pressing device 101 includes a guide rod 26 fixedly disposed between the left and right walls of the inclined slide cavity 16 and slidably connected to the inclined surface slider 17. The inclination angle of the guide slide rod 26 and the upper wall of the inclined slide cavity 16 is the same, and the inclination angles of the guide slide rod 26 and the upper wall of the inclined slide cavity 16 and the upper end of the inclined surface slider 17 are close to each other. A lower end of the center and a higher end far from the center. Compression chambers 27 are symmetrically provided on the front and back sides of the slanted slider 17, and a compression plate 28 is slidably arranged in the compression chamber 27. The lower end surface of the compression plate 28 is away from A fixed plate 29 is fixed at one end of the symmetrical center, and the lower end of the fixed plate 29 extends to the lower side of the slanted slider 17, and a rotating shaft 30 is rotatably provided between the lower ends of the fixed plate 29 on the front and back sides. 18 is fixed on the outer circular surface of the rotating shaft 30.

Advantageously, a compression spring 31 is fixedly connected between the end of the slanted surface slider 17 far from the center and the inner wall of the slanted slide cavity 16. When the slanted surface slider 17 moves to the side far away from the center of symmetry, it will squeeze the Compression spring 31, which can provide power for the slanted slider 17 to move toward the center, and a compression spring 32 is fixedly connected between the upper end of the compression plate 28 and the upper wall of the compression cavity 27, When the compression plate 28 moves up and compresses the down-pressure spring 32, the down-pressure spring 32 can provide power for the down movement of the compression plate 28.

According to the embodiment, the cutting device 102 is described in detail below. The cutting device 102 includes a rotating column 33 that is rotatably connected to the lower left corner between the front and rear walls of the cutting cavity 20, and the cutting blade 21 is fixedly disposed on the rotating column. At the upper end of the 33 outer circular surface, the turning column 33 is fixedly provided with a turning shaft 34 at its axial center, and a sprocket cavity 35 extending to the upper right side of the right telescopic plate 15 is provided at the rear side of the cutting cavity 20, and the turning shaft A rear end of 34 extends into the sprocket cavity 35, and a driven sprocket 36 is fixedly arranged. A driving sprocket 37 is provided on the left side of the sprocket cavity 35 and is rotatable in the right telescopic plate 15. A driving chain 38 is wound between the driving sprocket 37 and the driven sprocket 36, the driving sprocket 37 is fixedly provided with a driving shaft 39, and the front wall of the sprocket cavity 35 is directly opposite to the driving sprocket 37. The front side of the driving sprocket 37 is provided with a transmission cavity 40 located on the upper side of the inclined slide cavity 16 on the right side, and the front end of the transmission shaft 39 extends into the transmission cavity 40 to be fixed with a driven bevel gear 41. A spline hole shaft 42 penetrating the right telescopic plate 15 is rotatably provided in the left wall of the cavity 40, and the right end of the spline hole shaft 42 is fixedly provided with meshing with the driven Driving bevel gear 41, 43, the inner key hole flower splined shaft 42 and a spline shaft rotatably connected to the left end of the left wall 14 and right telescoping chamber 44.

Beneficially, a tape placement box 45 is fixed on the upper end of the fixing block 19, and the tape placement box 45 is provided with a placement cavity 46. A rear wall of the placement cavity 46 is fixed with a sleeve bar 47 that can be placed in the center of the tape. An adhesive tape opening 48 is provided between the lower wall of the placing cavity 46 and the upper wall of the cutting cavity 20. The initial end of the adhesive tape can enter the cutting cavity 20 through the adhesive tape opening 48.

According to the embodiment, the following is a detailed description of the hand control device 103. The hand control device 103 includes a turntable cavity 50 provided in the upper end face of the sealing machine 11, and a center of a lower wall of the turntable cavity 50 is provided with a power shaft. 51. The turntable 22 is rotatably provided in the turntable cavity 50 and fixedly disposed on the upper end of the power shaft 51. A bevel gear cavity 52 is provided on the lower wall of the turntable cavity 50, and the lower end of the power shaft 51 extends to A power bevel gear 53 is fixed in the bevel gear cavity 52, and a left end of the spline shaft 44 extends into the bevel gear cavity 52 and a transmission bevel gear 54 meshing with the power bevel gear 53 is fixed.

Beneficially, a torsion spring 55 is fixedly connected between the lower end of the turntable 22 and the lower wall of the turntable cavity 50, and the torsion spring 55 is tightened by rotation of the turntable 22, and the torsion spring 55 is a reverse of the turntable 22 The rotation resetting provides power. A handle 56 is fixed on the upper end of the turntable 22, and the handle 56 can be used to hold the sealing machine 11 and drive the turntable 22 to rotate.

Beneficially, a pressing cavity 57 is symmetrically provided on the front and back sides of the sealing machine 11, and a sliding plate 58 is slidably arranged in the pressing cavity 57. The upper end of the sliding plate 58 is fixed to the upper wall of the pressing cavity 57 A top pressure spring 59 is connected, and the top pressure spring 59 can move the sliding plate 58 down to provide power. The lower end of the sliding plate 58 is fixed with a connecting plate 60 extending to the lower side of the sealing machine 11, and the connecting plate A pressing plate 61 is fixed at the lower end of the pressing plate 61, and the pressing plate 61 is slightly lower than the lower end of the pressing roller 18.

The following describes in detail the use steps of a tape sealing machine suitable for various sizes of express boxes in this article with reference to FIGS. 1 to 4:

In the initial state, the left telescopic plate 13 is located at the right extreme position and retracted into the left telescopic cavity 12, the right telescopic plate 15 is at the left extreme position and retracted into the right telescopic cavity 14, the return spring 25 is in a relaxed state, and the inclined slider 17 is in the Near the center, the compression spring 31 is in a relaxed state, the pressing plate 61 is in a lower limit position, the pressing spring 59 is in a relaxed state, the pressing roller 18 is in a lower limit position, the pressing spring 32 is in a relaxed state, and the cutting blade 21 is in a vertical state. In a straight state and the crossing is upward, the tape is placed in the placement cavity 46 and sleeved on the sleeve rod 47. The starting end of the tape is stretched and passed through the tape opening 48 and the cutting cavity 20 to below the sealing machine 11.

When sealing, one hand lifts the sealing machine 11 through the handle 56 and the other hand pulls the starting end of the tape in the cutting cavity 20 and pulls from the lower side of the pressure roller 18 to the left side of the sealing machine 11 to stick the starting end first. On the side of the express box, then press the sealing machine 11 at the center of the upper side of the express box. The pressing plate 61 first flattens the two cardboards at the top and back of the box, and then the pressure roller 18 presses the lower side of the adhesive tape to flatten. The seam between the two front and back cardboards is then sealed, and the sealing machine 11 is further pressed down by the handle 56. At this time, the connection plate 60 is retracted into the pressing cavity 57 and the pressing spring 59 is compressed, and the fixing plate 29 is compressed. The pressure spring 32 is pressed in the cavity 27, and the slanted surface slider 17 is subjected to upward pressure at this time. Because the slant surface of the upper wall of the slanted cavity 16 and the upper end surface of the slanted slider 17 is set, the upward force of the slanted surface slider 17 is received. It will be disassembled to the side far from the center, and then drive the slanted sliders 17 away from each other and compress the compression spring 31. When the elastic force of the compression spring 31 is greater than the return spring 25, the left telescopic plate 13 will be moved to the left and the right telescopic plate 15 Move right and compress the return spring 25 to drive the pressure rollers 18 away from each other The tape is flattened on the courier box. When the pressure roller 18 moves to the side of the courier box, the compression plate 28 is lowered by the elastic force of the pressing spring 32. The fixing plate 29 is used to drive the pressure roller 18 to lower and stick the tape to the courier box. On the side, at this time, turning the handle 56 and driving the turntable 22 to rotate, driving the power bevel gear 53 through the power shaft 51, driving the transmission bevel gear 54 through the gear meshing and driving the spline shaft 44, and driving the spline through the spline connection The hole shaft 42 rotates and drives the driving bevel gear 43. The driven bevel gear 41 rotates through the gear meshing. The driving sprocket 37 rotates through the transmission shaft 39. The driven sprocket 36 rotates through the transmission chain 38. Drive the rotating column 33 to rotate and drive the cutting knife 21 to turn clockwise to a horizontal state. At this time, the cutting knife 21 pulls down the tape and punctures the tape, and then cuts the tape. At this time, the sealing machine 11 is lifted by the handle 56 and the sealing is completed. Manually smooth the cutting end stuck to the courier box.

The beneficial effect of the present invention is that by pressing the sealing machine on the upper side of the express box, the present invention first flattens the two cardboards at the opening of the express box, and then presses the tape on the seam between the cardboards to seal. Continue pressing down the sealing machine can drive the pressure rollers away from each other to the sides of the delivery box, and then flatten the tape on the delivery box, and the sealing machine has good flexibility, the pressure roller can be fixed in a larger range, can It is suitable for a variety of sizes of courier boxes, and has good storage and small space, and can be cut by turning the handle. The operation is convenient and the sealing effect of the tape is better.

In the above manner, those skilled in the art can make various changes according to the working mode within the scope of the present invention.

1. A tape sealing machine suitable for various sizes of courier boxes, including a sealing machine, characterized in that: the left side of the sealing machine is provided with a left telescopic cavity opening downward and to the left, and the left telescopic cavity can slide left and right A left telescopic plate is provided, and a right telescopic cavity with an opening downward and to the right is provided on the right side in the sealing machine, and a right telescopic plate is slidable in the right telescopic cavity;
The left telescopic plate and the right telescopic plate are provided with a pressing roller device inside and below, and the press roller device is provided with a slanting sliding cavity located in the left telescopic plate and the right telescopic plate and opening downward. A slanted slider is provided in the slanted sliding cavity to be able to slide left and right, and an upper end surface of the slanted slider is in contact with a slanted surface of the upper wall of the slanted sliding cavity. A pressure roller is provided on the lower side of the slant surface slider, and the tape is pulled to the lower side of the pressure roller. When the slant surface sliders are away from each other, the pressure rollers can be driven away from each other, and then the tape is flattened from the middle to both sides;
The right end of the right telescopic plate is fixedly provided with a fixing block located on the right side of the sealing machine, a cutting device is provided in the fixing block and the right telescopic plate, and an opening in the fixing block is provided in the cutting device. A downward and right cutting cavity, a cutting blade is provided on the left side in the cutting cavity, and the tape can be punctured and cut when the upper end of the cutting blade is turned to the right;
A manual control device is provided on the upper side of the sealing machine, and a rotary table is arranged in the manual control device. The rotary table is dynamically connected to the cutting blade, and the cutting blade can be turned when the rotary table is rotated.

2. The tape sealing machine suitable for multiple sizes of courier boxes according to claim 1, characterized in that a limiting cavity is provided in the left telescopic cavity and the upper wall of the right telescopic cavity, and the limiting cavity is inside the limiting cavity. Limiting blocks that are fixedly connected to the left telescopic plate and the upper end of the right telescopic plate are respectively slidable, and a return spring is fixedly connected between an end of the limit block far from the center and the inner wall of the limiting cavity.

3. The tape sealing machine applicable to various sizes of courier boxes according to claim 1, characterized in that the pressing roller device comprises fixedly disposed between the left and right walls of the slidable sliding cavity and slidingly connected to the inclined surface Guide slide bar in the slider, which maintains the same inclination with the upper wall of the inclined slide cavity, the inclination angle of the guide slide bar with the upper wall of the inclined slide cavity and the upper end of the inclined slide In order to be low near the center and high away from the center, compression chambers are symmetrically arranged on the front and back sides of the slanted slider, and compression plates are slidably arranged in the compression chamber. The lower end of the compression plate is far from the symmetrical center. A fixed plate is fixedly arranged, the lower end of the fixed plate extends to the lower side of the slanted slider, a rotary shaft is rotatably provided between the lower ends of the fixed plate on the front and back sides, and the pressure roller is fixedly arranged on the outer circle of the rotary shaft surface.

4. The tape sealing machine applicable to various sizes of courier boxes according to claim 1, characterized in that: a pressure-resistant spring is fixedly connected between an end of the inclined surface slider away from the center and the inner wall of the inclined sliding cavity, A lower pressing spring is fixedly connected between the upper end of the compression plate and the upper wall of the compression cavity.

5. The tape sealing machine applicable to various sizes of courier boxes according to claim 1, wherein the cutting device comprises a rotating column connected to the lower left corner between the front and rear walls of the cutting cavity, and the cutting A knife is fixed at the upper end of the outer circular surface of the rotating column, a rotating shaft is fixed at the axis of the rotating column, and a sprocket cavity extending to the upper right side of the right telescopic plate is provided at the rear side of the cutting cavity. The rear end of the turning shaft extends into the sprocket cavity to be fixed with a driven sprocket, and the left side of the sprocket cavity is provided with a driving sprocket that is rotatable in the right telescopic plate. The driving sprocket A transmission chain is wound around the driven sprocket. The driving sprocket axis is fixed with a transmission shaft. The front wall of the sprocket cavity is directly opposite to the front side of the driving sprocket. The transmission cavity on the upper side of the slidable sliding cavity, the front end of the transmission shaft is fixedly provided with a driven bevel gear in the transmission cavity, and a flower penetrating the right telescopic plate is rotatably provided in the left wall of the transmission cavity. A key hole shaft, a driving bevel gear meshing with the driven bevel gear is fixed at the right end of the spline hole shaft, A spline shaft with a left end rotatably connected to the left wall of the right telescopic cavity is splined in the spline hole shaft.

6. The tape sealing machine applicable to various sizes of courier boxes according to claim 1, characterized in that: a tape placement box is fixed at the upper end of the fixing block, and a placement cavity is provided in the tape placement box, wherein The back wall of the placement cavity is fixedly provided with a sleeve rod that can be sleeved on the center of the tape, and a tape passage is provided between the lower wall of the placement cavity and the upper wall of the cutting cavity.

7. The tape sealing machine applicable to multiple sizes of express boxes according to claim 1, wherein the manual control device includes a turntable cavity provided in an upper end surface of the sealer, and a center of a lower wall of the turntable cavity A power shaft is rotatably provided. The turntable is rotatably provided in the turntable cavity and fixedly disposed at the upper end of the power shaft. A bevel gear cavity is provided on the lower wall of the turntable cavity, and the lower end of the power shaft extends to A power bevel gear is fixed in the bevel gear cavity, and a left end of the spline shaft extends into the bevel gear cavity. A transmission bevel gear meshing with the power bevel gear is fixed.

8. The tape sealing machine applicable to various sizes of express boxes according to claim 1, wherein a torsion spring is fixedly connected between the lower end of the turntable and the lower wall of the turntable cavity, and the upper end of the turntable is fixedly arranged. There are handles.

9. The tape sealing machine suitable for multiple sizes of courier boxes according to claim 1, characterized in that: pressing chambers are symmetrically arranged on the front and back sides of the sealing machine, and the pressing chambers are slidably arranged up and down. A sliding plate, an upper pressing spring is fixedly connected between the upper end of the sliding plate and the upper wall of the pressing cavity, the pressing spring can move the sliding plate to provide power, and the lower end of the sliding plate is fixedly provided to the sealing machine A lower connecting plate, a pressing plate is fixed at the lower end of the connecting plate, and the pressing plate is slightly lower than the lower end of the pressing roller.
